(19) United States
(12) Patent Application Publication
(10) Pub. No.: US 2007/0024667 A1
(43) Pub. Date: Feb. 1, 2007

(54) Inkjet image forming apparatus and printing method

(75) Inventor: Jung-hwan Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/475,183

(22) Filed: Jun. 27, 2006

(30) Foreign Application Priority Data
Jul. 28, 2005 (KR) 2005-69114

(51) Int. Cl. B41J 2/15; B41J 2/145

(52) U.S. Cl. 347/41

(57) ABSTRACT

An inkjet image forming apparatus and a printing method for the same. The printing method includes dividing image data to be printed in a single line into “n” groups, reducing a transferring speed of a print medium, and sequentially printing the divided “n” groups in “n” lines. The image data to be printed in the single line is divided and printed with a predetermined driving frequency. A transferring speed of the print medium is controlled to print the image data such that an instantaneous maximum consumption current and an average consumption current are reduced, resulting in the use of the smaller capacity power supply. The print medium is slowly transferred and the divided image data is sequentially printed, thereby enhancing printing quality.

### CROSS-REFERENCE TO RELATED APPLICATIONS

This application claims the benefit of Korean Patent Application No. 2005-69114, filed on Jul. 28, 2005, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus, and more particularly, to an inkjet image forming apparatus and a printing method which can reduce a maximum consumption current and an average consumption current used to drive a printhead to eject ink.

2. Description of the Related Art

In general, an inkjet image forming apparatus forms images by ejecting ink from a printhead, which is positioned a predetermined distance apart from a print medium and reciprocally moves in a direction perpendicular to a transferring direction of the print medium. This type of inkjet image forming apparatus is referred to as a shuttle type inkjet image forming apparatus. Recently, a printhead having a nozzle unit with a length that corresponds to a width of the print medium has been used to obtain high-speed printing. This type of image forming apparatus operated in this manner is referred to as a line printing type inkjet image forming apparatus.

In the line printing type inkjet image forming apparatus, the printhead is fixed and only the print medium is transferred. During printing, the print medium is transferred in a direction that is perpendicular to the printhead, and the printhead ejects ink on the print medium to print image data. Accordingly, the line printing type inkjet image forming apparatus can print image data that corresponds to the width of the print medium all at once, thereby realizing high speed printing. When the image data that corresponds to the width of the print medium is printed all at once, a high capacity power supply is required for driving the nozzles, since many nozzles are driven simultaneously.

FIG. 1 illustrates a resolution and an amount of current supplied in a general printing process of a conventional inkjet image forming apparatus. FIG. 2 illustrates a conventional printing method for reducing the amount of current supplied in the general printing process of FIG. 1.

Referring to FIG. 1, when an inkjet image forming apparatus prints with a resolution of 1200 dots per inch (dpi), a print medium is transferred at a speed of 10 inches per second (ips), and if it is assumed that an instantaneous maximum consumption current (IMC) is 50 A, a printing frequency of a printhead for printing a single line is 12 kHz, a nozzle ejection duty is 50%, and an average consumption current (AC1) is 25 A (50 A×50%=25 A).

Referring to FIG. 2, if the printing frequency for driving the printhead is reduced to 6 kHz and the transferring speed of the print medium is reduced to 5 ips, the printing resolution can be the same as that of FIG. 1. When the printing frequency of the printhead is reduced by one half, a printing period increases two times and the average consumption current (AC2) becomes 12.5 A (50 A×25%=12.5 A). Therefore, the average consumption current (AC2) supplied by a power supply can be reduced.

As described above, in the conventional method for reducing the amount of current supplied (i.e., the average consumption current for driving the printhead), the instantaneous maximum consumption current (IMC) cannot be reduced. Accordingly, a small capacity power supply cannot be used in view of the required amount of the instantaneous maximum consumption current and the average consumption current. In addition, in the conventional method of reducing the current supplied of FIG. 2, the printing speed is reduced by one half (from the general printing process illustrated in FIG. 1), however printing quality is not enhanced because the vertical resolution is not changed.

### SUMMARY OF THE INVENTION

The present general inventive concept provides an inkjet image forming apparatus and a printing method, which can reduce a maximum consumption current and an average consumption current to drive a printhead and enhance printing quality.

Additional aspects of the present general inventive concept will be set forth in part in the description which follows and, in part, will be obvious from the description, or may be learned by practice of the general inventive concept.

The foregoing and or other aspects of the present general inventive concept may be achieved by providing an inkjet image forming apparatus including a print medium transferring unit to transfer a print medium in a first direction, a printhead which has a nozzle unit with a length that corresponds to a width of the print medium and is installed along a second direction, an ejection driving unit to drive the printhead with a predetermined frequency to print an image on the print medium, and a control unit which generates control signals to control operations of the print medium transferring unit, the printhead, and the ejection driving unit such that image data corresponding to a single line is divided into “n” groups and the divided “n” groups are sequentially printed in “n” lines by reducing a transferring speed of the print medium.

The control unit may include a memory unit to store image data input from a host, a data dividing unit which reads the image data from the memory unit and divides the image data that corresponds to the single line into the divided “n” groups, a printhead driving unit which separately drives nozzles in the nozzle unit of the printhead such that the image data of each group is printed in a corresponding line, and a printing speed determining unit which controls the operation of the print medium transferring unit according to a number of the divided “n” groups to reduce the transferring speed of the print medium.

The data dividing unit may divide the image data in each group by alternating “n” times in a total number of nozzles such that ink droplets ejected from the printhead are ejected to each position corresponding to “n” times a single nozzle pitch for printing the image data.

The printhead driving unit may separately drive the printhead such that ink droplets for the divided “n” groups form a plurality of slanted lines on the print medium.

The printhead driving unit may separately drive the printhead such that the plurality of slanted lines have an inclination angle that is the same.

The printhead driving unit may drive the printhead such that the predetermined driving frequency at which the printhead is driven when printing the divided “n” groups is equal to a driving frequency when the image data is printed in the single line by operating all corresponding nozzles at the same time.

The print speed determining unit may determine that the print medium is transferred at a speed that is 1/n of a print medium transferring speed in a normal printing mode.

A value of “n” may be equal to 2.

The foregoing and/or other aspects of the present general inventive concept may also be achieved by providing an inkjet image forming apparatus, comprising a printhead having a plurality of nozzles arranged along a line thereof, and a control unit to operate the printhead to print a line of image data using the line of nozzles of the printhead simultaneously in a first mode and to print the line of the image data using alternating groups within the line of nozzles sequentially in a second mode.

The foregoing and/or other aspects of the present general inventive concept may also be achieved by providing an inkjet image forming apparatus, comprising a print head having a width that corresponds to a width of a print medium, a print medium transferring unit to transfer the print medium under the print head, and a control unit to control the apparatus between at least a normal mode and a high resolution mode. The control unit comprises a data dividing unit to receive image data that corresponds to a single line in a predetermined print area and to divide the received image data into a plurality of lines in the predetermined print area when the control unit operates in the high resolution mode, and a print speed determining unit to control the print medium transferring unit to transfer the print medium at a normal speed when the control unit operates in the normal mode and to control the print medium transferring unit to transfer the print medium at a high resolution speed that is less than the normal speed when the apparatus operates in the high resolution mode.

The foregoing and/or other aspects of the present general inventive concept may also be achieved by providing an image forming system, comprising a host device to output image data, and an inkjet image forming apparatus to receive the image data from the host device, the inkjet image forming apparatus comprising a printhead having a plurality of nozzles arranged along a line thereof, and a control unit to operate the printhead to print a line of the image data using the line of nozzles of the printhead simultaneously in a first mode and to print the line of the image data using alternating groups within the line of nozzles sequentially in a second mode.

The foregoing and/or other aspects of the present general inventive concept may also be achieved by providing a printing method of an image forming apparatus having a printhead including a nozzle unit with a length that corresponds to a width of a print medium, the method including dividing image data to be printed in a single line into “n” groups, determining a transferring speed of the print medium according to a number of the divided “n” groups, and sequentially printing the divided “n” groups in “n” lines according to the determined transferring speed of the print medium.

The sequential printing of the divided “n” groups in the “n” lines may comprise printing the image data in each group in a corresponding line.

The image data in each group may be divided such that ink droplets ejected from the printhead are ejected to each position that corresponds to “n” times a single nozzle pitch for printing the image data.

The printhead may be separately driven such that ink droplets for the divided “n” groups form a plurality of slanted lines on the print medium.

The printhead may be separately driven such that the plurality of slanted lines have an inclination angle that is the same.

The printhead may be driven such that a driving frequency at which the printhead is driven in the divided “n” groups is equal to a driving frequency when the image data is printed in the single line.

The print medium may be transferred at a speed that is 1/n of a print medium transferring speed in a normal printing mode.

A value of “n” may be equal to 2.

The foregoing and/or other aspects of the present general inventive concept may also be achieved by providing a control method of an inkjet image forming apparatus including a printhead having a plurality of nozzles arranged along a line thereof, the method comprising controlling the printhead between a first mode in which the printhead prints a line of image data using the line of nozzles of the printhead simultaneously and a second mode in which the printhead prints the line of the image data using alternating groups within the line of nozzles sequentially in a second mode.

The foregoing and/or other aspects of the present general inventive concept may also be achieved by providing a computer readable medium containing executable code to control an image forming apparatus having a printhead including a nozzle unit with a length that corresponds to a width of a print medium, the medium comprising executable code to divide image data to be printed in a single line into “n” groups, executable code to determine a transferring speed of the print medium according to a number of the divided “n” groups, and executable code to sequentially print the divided “n” groups in “n” lines according to the determined transferring speed of the print medium.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 illustrates a resolution and an amount of current supplied in a general printing process of a conventional inkjet image forming apparatus;

FIG. 2 illustrates a conventional printing method for reducing the current supplied in the general printing process of FIG. 1;

FIG. 3 is a schematic view illustrating an inkjet image forming apparatus according to an embodiment of the present general inventive concept;

FIG. 4 illustrates a printhead unit of the inkjet image forming apparatus of FIG. 3 according to an embodiment of the present general inventive concept;

FIG. 5 illustrates a driving mechanism of a printhead of the inkjet image forming apparatus of FIG. 3 according to an embodiment of the present general inventive concept;

FIG. 6 is a block diagram illustrating an image forming system according to an embodiment of the present general inventive concept;

FIG. 7 is a block diagram illustrating an image forming apparatus of the image forming system of FIG. 6 according to an embodiment of the present general inventive concept;

FIG. 8A illustrates image data to be printed in a single line according to an embodiment of the present general inventive concept;

FIG. 8B illustrates printing patterns when the image data of FIG. 8A is divided into “n” groups for printing according to an embodiment of the present general inventive concept;

FIG. 9 is a flow chart illustrating a printing method of an image forming apparatus according to an embodiment of the present general inventive concept; and

FIG. 10 illustrates a printing pattern when image data that corresponds to a single line is divided into two groups for printing according to an embodiment of the present general inventive concept.

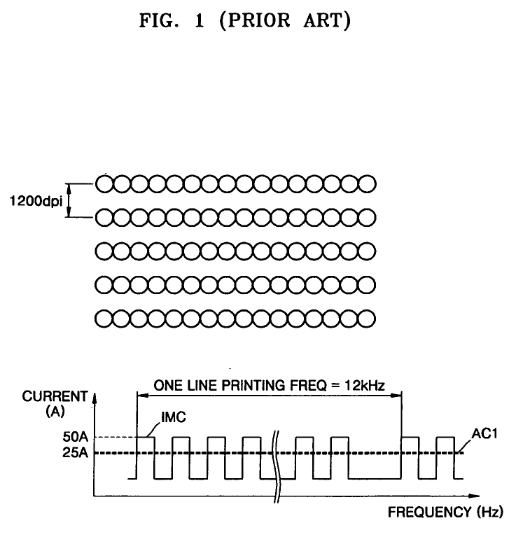

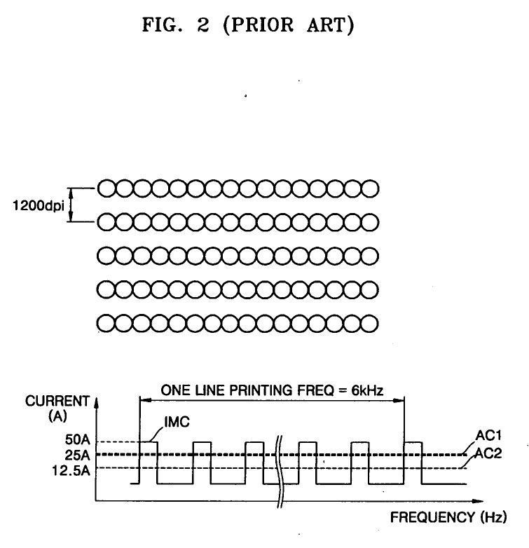

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

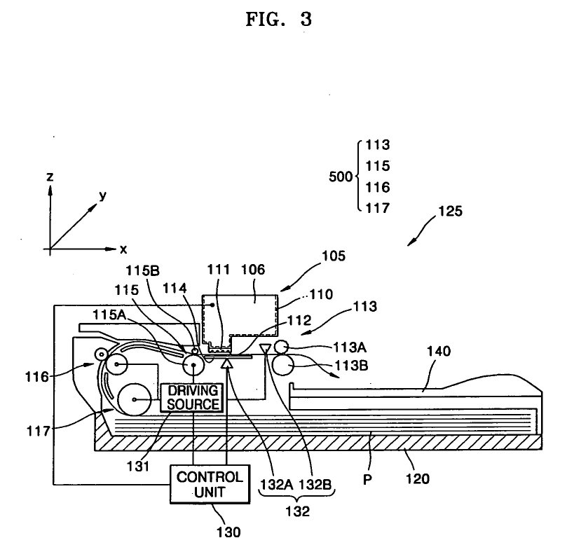

FIG. 3 is a schematic view illustrating an inkjet image forming apparatus according to an embodiment of the present general inventive concept.

Referring to FIG. 3, the inkjet image forming apparatus 125 includes a feeding cassette 120, a printhead unit 105, a supporting member 114 opposite to the printhead unit 105, a detecting unit 132 to detect a malfunctioning nozzle, a print medium transferring unit 500 to transfer a print medium P in a first direction (i.e., an x direction) and a stacking unit 140 on which the discharged print medium P is stacked. In addition, the inkjet image forming apparatus 125 further includes a control unit 130 to control each component thereof.

The print medium P is stacked on the feeding cassette 120. The print medium P is transferred from the feeding cassette 120 to a printhead 111 by the print medium transferring unit 500, which is described below.

The print medium transferring unit 500 transfers the print medium P along a predetermined path and includes a pick-up roller 117, an auxiliary roller 116, a feeding roller 115, and a discharging roller 113. The print medium transferring unit 500 is driven by a driving source 131, such as a motor, and provides a transferring force to transfer the print medium R The driving source 131 is controlled by the control unit 130, which is described below. That is, the control unit 130 controls operation of the driving source 131 to set a speed with which the print medium P is transferred.

The pick-up roller 117 is installed at one side of the feeding cassette 120 and picks up the print medium P stacked in the feeding cassette 120. The feeding roller 115 is installed at an inlet side of the printhead 111 and feeds the print medium P picked up by the pick-up roller 117 to the printhead 111. The feeding roller 115 includes a driving roller 115A to supply a transferring force to transfer the print medium P, and an idle roller 115B elastically engaged with the driving roller 115A. The auxiliary roller 116 that transfers the print medium P may be further installed between the pick-up roller 117 and the feeding roller 115. The discharging roller 113 is installed at an outlet side of the printhead 111 and discharges the print medium P on which the printing has been completed outside of the image forming apparatus 125.

The discharged print medium P is stacked on the stacking unit 140. The discharging roller 113 includes a star wheel 113A installed along a widthwise direction of the print medium P, and a supporting roller 113B which is opposite to the star wheel 113A that supports a rear side of the print medium P. The print medium P may wrinkle due to ink ejected onto a top side of the print medium P while passing through the printhead 111. If the wrinkling is severe, the print medium P may contact a bottom surface of a nozzle unit 112 or a body 110, wet ink may be smeared on the print medium P, and an image printed thereon may be contaminated. A distance between the print medium P and the nozzle unit 112 may not be maintained due to the wrinkles of the print medium R The star wheel 113A prevents the print medium P fed underneath the nozzle unit 112 from contacting the bottom surface of the nozzle unit 112 or the body 110, and prevents a distance between the print medium P and the bottom surface of the nozzle unit 112 or the body 110 from being changed. The star wheel 113A is installed such that at least a portion of the star wheel 113A protrudes from the nozzle unit 112, and contacts the print medium P at a top surface thereof.

The supporting member 114 is installed below the printhead 111 and supports the rear side of the print medium P to maintain the distance between the nozzle unit 112 and the print medium P. The distance between the nozzle unit 112 and the print medium P may be about 0.5-2.5 mm.

The detecting unit 132 detects a malfunctioning nozzle which is generated in a manufacturing process or during a printing process. The malfunctioning nozzle indicates a defective nozzle or a nozzle that does not eject droplets of ink. That is, the malfunctioning nozzle exists when ink is not ejected from the nozzle or when an amount of ink that is less than a regular amount of ink is ejected from the nozzle. The malfunctioning nozzle is generated in a process of manufacturing the printhead 111 or during the printing process. In general, information about the malfunctioning nozzle generated in the manufacturing process may be stored in a memory (not shown) installed in the printhead 111. The stored information can be transmitted to the inkjet image forming apparatus 125 when the printhead 111 is mounted in the inkjet image forming apparatus 125. The detecting unit 132 may include a first detecting unit 132A to detect malfunctioning nozzles in the nozzle unit 112 before printing and a second detecting unit 132B to detect malfunctioning nozzles in the nozzle unit 112 during printing. The detecting unit 132 sends the detected information to the control unit 130, which is described below. The detecting unit 132 may include an optical sensor. For example, the optical sensor may include a light-emitting sensor such as a light emitting diode that radiates light onto the print medium P and a light-receiving sensor that receives light reflected from the print medium P. An output signal from the light-receiving sensor may be input to the detecting unit 132. The second detecting unit 132B detects whether or not a malfunctioning nozzle exists in the nozzle unit 112 in response to the output signal, and the information about whether or not the malfunctioning nozzle exists in the nozzle unit 112 may be provided to the control unit 130, which is described below. The light emitting sensor and the light receiving sensor can be formed in a composite body type or as several separate units. The structures and functions of the optical sensor should be known to those of ordinary skill in the art, and thus a detailed description thereof will not be provided.

The printhead unit 105 prints an image by ejecting ink onto the print medium P, and includes the body 110, the printhead 111 installed in one side of the body 110, a nozzle unit 112 formed on the printhead 111, and a carriage 106 in which the body 110 is mounted. The body 110 is mounted in the carriage 106 in a cartridge type manner. The feeding roller 115 is rotatably installed at the inlet side of the nozzle unit 112, and the discharging roller 113 is rotatably installed at the outlet side of the nozzle unit 112.

Although not shown, a removable cartridge type ink container may be provided in the body 110. Further, the body 110 may include chambers, each of which has an ejection driving unit therein, for example, piezoelectric elements or heat-driving typed heaters, that are connected to respective nozzles of the nozzle unit 112 to provide pressure to eject the ink, a passage, for example, an orifice, to supply the ink contained in the body 110 to each chamber, a manifold that is a common passage to supply the ink that flows through the passage to the respective chamber, and a restrictor that is an individual passage to supply the ink from the manifold to each chamber. The chamber, the ejection driving unit, the passage, the manifold, and the restrictor should be known to those skilled in the art, and thus a detailed description thereof will not be provided. In addition, the ink container (not shown) may be installed separately from the printhead unit 105. The ink stored in the ink container may be supplied to the printhead unit 105 through a supplying unit like a hose.

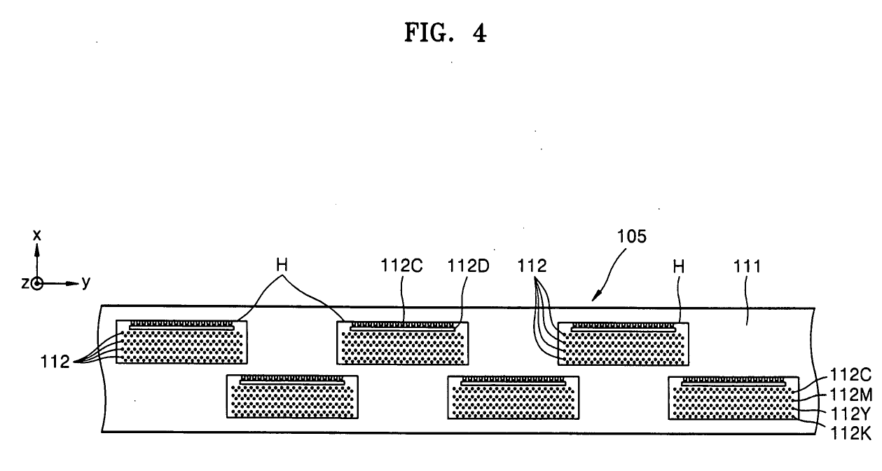

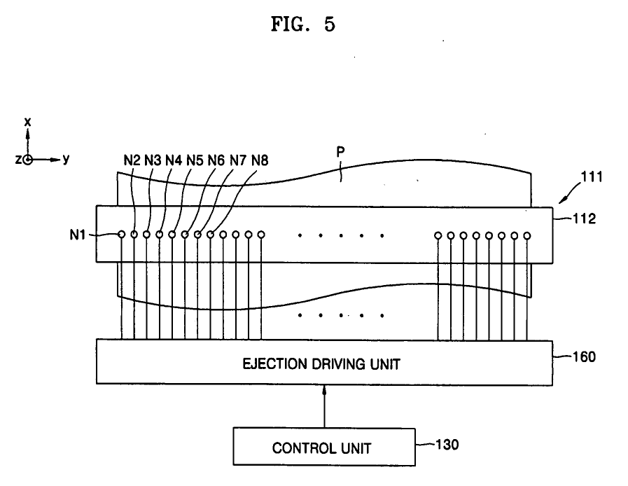

FIG. 4 illustrates the printhead unit 105 of the inkjet image forming apparatus of FIG. 3 according to an embodiment of the present general inventive concept. FIG. 5 illustrates a driving mechanism of the printhead 111 of the inkjet image forming apparatus of FIG. 3 according to an embodiment of the present general inventive concept. For illustration purposes, like reference numerals in FIGS. 3 through 5 represent like elements. In FIG. 5, reference characters N1 through N8 represent nozzles disposed in the nozzle unit 112. A single nozzle array disposed in the nozzle unit 112 is described as an example, however, it should be understood that the nozzle unit 112 may include a plurality of nozzle arrays.

Referring to FIGS. 3 and 5, an ejection driving unit 160 provides an ejecting force to ink droplets to drive the printhead 111 with a predetermined frequency to print an image on the print medium P. The ejection driving unit 160 can be classified as one of two types according to an actuator that provides the ejecting force to the ink droplets in the printhead 111. The first type is a thermal driving printhead that generates bubbles in ink using a heater, thereby ejecting the ink droplets due to an expanding force of the generated bubbles. The second type is a piezoelectric driving printhead that ejects the ink droplets using a pressure applied to the ink due to deformation of a piezoelectric device. The ejection driving unit 160 that drives the nozzles in the nozzle unit 112 is controlled by the control unit 130, which is described below.

Referring to FIGS. 3 and 4, the printhead 111 is installed along a second direction (i.e., a y direction) with respect to the print medium P that is transferred along the first direction (i.e., the x direction). The printhead 111 uses heat energy or a piezoelectric device as an ink ejecting source, and is made to have a high resolution through a semiconductor manufacturing process including, for example, etching, deposition, or sputtering. The printhead 111 includes the nozzle unit 112 to eject the ink onto the transferred print medium P The nozzle unit 112 may have a length that corresponds to the width of the print medium P or may be formed longer than the width of the print medium P.

Referring to FIG. 4, a plurality of head chips H having a plurality of nozzle row arrays 112C, 112M, 112Y, and 112K may be formed in the printhead 111. Each of the head chips H has a driving circuit 112D which selectively drives nozzles individually or in groups of nozzles. When the plurality of head chips H are arranged in a single line, a distance between the head chips H may become greater than a distance between the nozzles in each head chip H, thereby generating an unprinted portion. Therefore, the plurality of head chips H may be arranged in a zigzag shape. Each of the nozzle row arrays of the nozzle row arrays 112C, 112M, 112Y, and 112K in the head chip H which eject ink of the same color may be disposed to overlap with one another to enhance printing resolution in the second direction (i.e., the y direction). For example, a cyan nozzle row array 112C of a first head chip H may overlap with the cyan nozzle row array 112C of a second head chip H. In this case, ink dots ejected by the nozzles in the nozzle row arrays may be ejected to positions between ink dots ejected by the nozzles in the other nozzle row arrays, thereby enhancing printing resolution in the second direction (i.e., the y direction). It should be understood that the printhead 111 having the nozzle unit 112 and the plurality of head chips H is described as an example in the present embodiment, and the nozzle unit 112 may have various other shapes. For example, a nozzle row array may be arranged along the second direction, as illustrated in FIG. 5. That is, each of the head chips H may be formed of one chip having a length that is equal to that of the printhead 111 (i.e., the width of the print medium P). Accordingly, the arrangement of the nozzle unit 112 illustrated in FIG. 3 is not intended to limit the scope of the present general inventive concept.

Each of the nozzles in the nozzle unit 112 includes the driving circuit 112D and a cable 112E to receive printing data, electric power, control signals, etc. The cable 112E may be a flexible printed circuit (FPC) or a flexible flat cable (FFC).

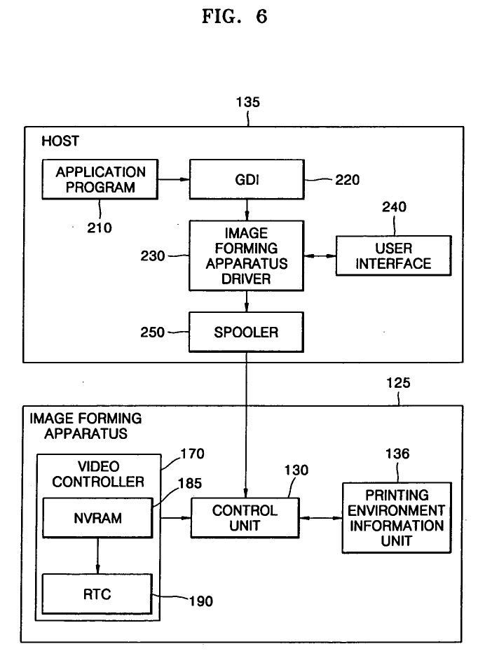

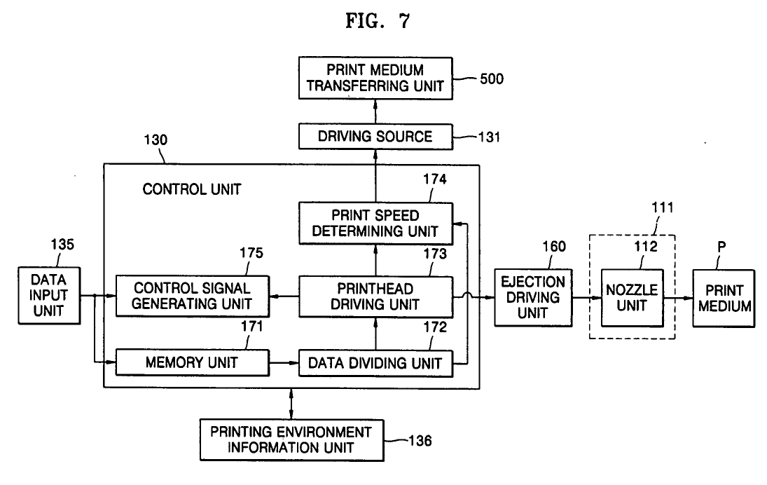

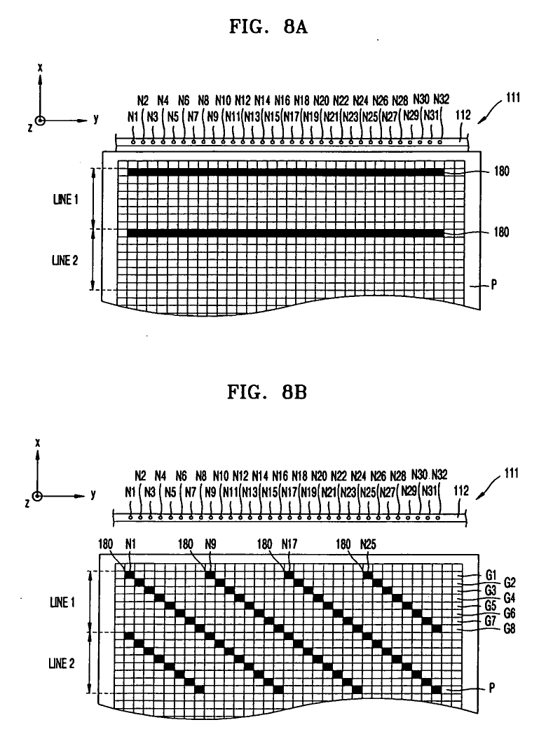

FIG. 6 is a block diagram illustrating an image forming system including the inkjet image forming apparatus 125 of FIG. 3 according to an embodiment of the present general inventive concept. FIG. 7 is a block diagram illustrating the inkjet image forming apparatus 125 of the image forming system of FIG. 6 according to an embodiment of the present general inventive concept. The image forming system includes a data input unit 135 and the inkjet image forming apparatus 125. FIG. 8A illustrates image data to be printed in a single line. FIG. 8B illustrates printing patterns when the image data of the single line of FIG. 8A is divided into “n” groups for printing.

Referring to FIG. 6, the data input unit 135 may be a host system such as a personal computer (PC), a digital camera, or a personal digital assistant (PDA) and receives image data in an order of pages to be printed. The data input unit 135 includes an application program 210, a graphics device interface (GDI) 220, an image forming apparatus driver 230, a user interface 240, and a spooler 250.

The application program 210 generates and edits an object that can be printed by the inkjet image forming apparatus 125. The GDI 220, which is a program installed on the host system (i.e., the data input unit 135), receives the object from the application program 210, sends the object to the image forming apparatus driver 230, and generates commands related to the object in response to a request from the image forming apparatus driver 230. The image forming apparatus driver 230 is a program installed on the host system (i.e., the data input unit 135) to generate commands that can be interpreted by the inkjet image forming apparatus 125. The user interface 240 for the image forming apparatus driver 230 is a program installed in the host system that provides environment variables with which the image forming apparatus driver 230 generates commands. A user may select a print mode such as a draft mode, a normal mode, and a resolution enhanced mode via the user interface 240. The resolution enhanced mode may be a high resolution mode. The spooler 250 is a program installed in an operating system of the host system (i.e., the data input unit 135) and transmits the commands generated by the image forming apparatus driver 230 to an input/output device (not shown) that is connected to the inkjet image forming apparatus 125.

The inkjet image forming apparatus 125 includes a video controller 170, the control unit 130, a printing environment information unit 136. The video controller 170 may include a non-volatile random access memory (NVRAM) 185 and a real time clock (RTC) 190. The video controller 170 may further include a static random access memory (SRAM-not shown), a synchronous dynamic random access memory (SDRAM-not shown), and/or a NOR Flash memory (not shown). The video controller 170 interprets commands generated by the image forming apparatus driver 230 to convert the commands into corresponding bitmaps and provides the bitmaps to the control unit 130, which is described below. The control unit 130 provides the bitmaps to each component of the inkjet image forming apparatus 125 to print an image on the print medium P.

Referring to FIG. 7, the control unit 130 is mounted on a motherboard (not shown) of the inkjet image forming apparatus 125, and generates control signals to control operations of the print medium transferring unit 500, the printhead 111, and the ejection driving unit 160 such that image data to be printed in a single line is divided into “n” groups, a transferring speed of print medium P is reduced, and thus the image data divided “n” groups is sequentially printed in “n” lines. The control unit 130 includes a memory unit 171, a data dividing unit 172, a print head driving unit 173, a print speed determining unit 174, and a control signal generating unit 175.

The control unit 130 stores image data transmitted from the data input unit 135 (i.e., the host system) in the memory unit 171 and confirms whether or not the image data to be printed is completely stored in the memory unit 171.

When image data that corresponds to the single line is printed in the single line all at once, power consumption is large. Therefore, the image data may be divided into a plurality of groups (i.e. “n”) and then the single printing line illustrated in FIG. 8A is divided and printed sequentially as illustrated in FIG. 8B. Referring to FIGS. 7-8B, the data dividing unit 172 reads the image data stored in the memory unit 171 and divides the image data to be printed in the single line as illustrated in FIG. 8A into the “n” groups G1 through Gn as illustrated in FIG. 8B. Hereinafter, for illustration purposes, the image data of FIG. 8A is divided into eight groups, however, this description is merely exemplary and is not intended to limit the scope of the present general inventive concept. A “line” as used throughout this detailed description and in FIGS. 8A and 8B may be a predetermined area on the print medium P in which the printhead 111 prints each line of ink dots when the inkjet image forming apparatus operates in the normal mode. The line may be a line area (e.g., line 1 and line 2 in FIGS. 8A and 8B) on the print medium P having a plurality of pixel lines. As illustrated in FIGS. 8A and 8B, each line including line 1 and line 2 has eight pixel lines. In the normal mode, a line of image data is printed in a single pixel line at once. On the other hand, as illustrated in FIG. 8B, in the resolution enhanced mode, the line of image data is printed in all eight pixel lines by reducing the print medium transferring speed and operating the nozzle groups G1 through G8 at eight different times.

The data dividing unit 172 may divide the image data such that the image data in each group is printed on each position that corresponds to eight times a single nozzle pitch of the printhead 111. That is, the image data may be divided such that, for example, the image data in a first group G1 is printed with nozzles N1, N9, N17, and N25, the image data in a second group G2 is printed with nozzles N2, N10, N18, and N26, the image data in a third group G3 is printed with nozzles N3, N11, N19, and N27, etc., as illustrated in FIG. 8B.

The printhead driving unit 173 controls the operation of the ejection driving unit 160 to separately drive the printhead 111 such that image data in the same group is printed in the same line (i.e. same pixel line). That is, the printhead driving unit 173 separately drives the printhead 111 such that image data in the first group G1 is printed in a first line (i.e., a first pixel line in a corresponding line area) and image data in the second group G2 is printed in a second line (i.e., a second pixel line in the same corresponding line area), etc., as illustrated in FIG. 8B. The image data that corresponds to a single line (i.e. a single line area) is divided and sequentially printed in eight lines (i.e., eight pixel lines instead of one pixel line) such that an instantaneous maximum consumption current supplied to drive the printhead 111 and an average consumption current can be reduced. That is, the image data to print the single line is reduced ⅛ times, and thus, the instantaneous maximum consumption current and the average consumption current are reduced ⅛ times.

The printhead driving unit 173 may separately drive the printhead 111 such that the image data that is divided into the eight groups G1 through G8 is printed on the print medium P to form a plurality of slanted lines. The printhead driving unit 173 may drive the printhead 111 such that the plurality of slanted lines have the same inclination angle, as illustrated in FIG. 8B. As illustrated in FIGS. 8A and 8B, the image data is printed in “n” lines (i.e., “n” pixel lines within the corresponding line area) by forming the slanted lines such that the resolution of the image data along the transferring direction of the print medium P is enhanced compared with the resolution of the image data when the image data is printed in the single line (i.e., the single pixel line in the normal mode). That is, as illustrated in FIG. 8B, ink droplets ejected from nozzles that correspond to the “n” groups G1 through GN are ejected to constantly divided positions in the Line1 and Line2 in the transferring direction of the print medium P, thereby enhancing the resolution of the image data along the transferring direction of the print medium P.

The printhead driving unit 173 may drive the printhead 111 such that a driving frequency with which the printhead 111 is driven to print in the resolution enhanced mode (see FIG. 8B) equal to a driving frequency of the printhead 111 when image data is printed in the single line in the normal mode (see FIG. 8A). In general, when the image data that corresponds to the single line is divided into “n” groups for printing, a time for printing the single line increases, and thus, the frequency of the printhead 111 increases. However, the print speed determining unit 174, which is described below, transfers the print medium P at a speed that is 1/n of a print medium transferring speed in the normal mode such that the driving frequency of the printhead 111 does not change.

The print speed determining unit 174 controls the operation of the print medium transferring unit 500 according to the number of the groups to reduce the transferring speed of the print medium P. As described above, a printing method according to the present embodiment divides the image data to be printed in a single line into “n” lines for printing. When the print medium P is transferred at the same speed as in the normal mode, the resolution of the image data in the transferring direction of the print medium P may be degraded. Therefore, the print medium P is decelerated for printing. When the image data is divided into the “n” groups for printing, the print speed determining unit 174 may transfer the print medium P at a speed that is 1/n of the print medium transferring speed in the normal mode.

The control signal generating unit 175 generates control signals to control the operations of each component of the inkjet image forming apparatus 125 for printing according to the image data input from the data input unit 135 (i.e., the host system) and signals input from the data dividing unit 172, the printhead driving unit 173, and the print speed determining unit 174.

The printing environment information unit 136 stores a plurality of printing environment information that correspond to each printing environment when the image data input from the application program 210 is printed in a predetermined printing environment. That is, the printing environment information unit 136 stores printing environment information that corresponds to each printing environment input from the user interface 240. Here, the printing environment may include at least one of a printing density, a resolution, a size of the print medium, a type of the print medium, a temperature, a humidity, and a continuous printing. The control unit 130 controls the operations of the printhead 111, a carriage moving unit, and the print medium transferring unit 500 in each printing environment stored in the printing environment information unit 136 that corresponds to the input printing environment. For example, when the normal mode is input from the user interface 240, the printing may be performed in the manner illustrated in FIG. 8A. When a resolution enhanced mode is input, the printing may be performed in the manner illustrated in FIG. 8B. In the resolution enhanced mode, the print medium P is transferred at a low speed and the image data is divided into the “n” groups and printed such that the resolution of the image data is enhanced and a malfunctioning nozzle may be compensated for. As described above, the printing environment information input through the user interface 240 may be stored in the printing environment information unit 136.

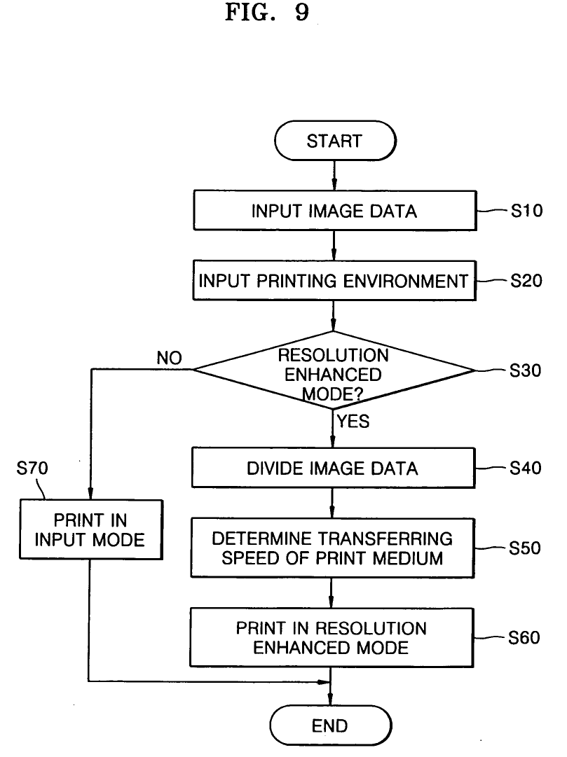

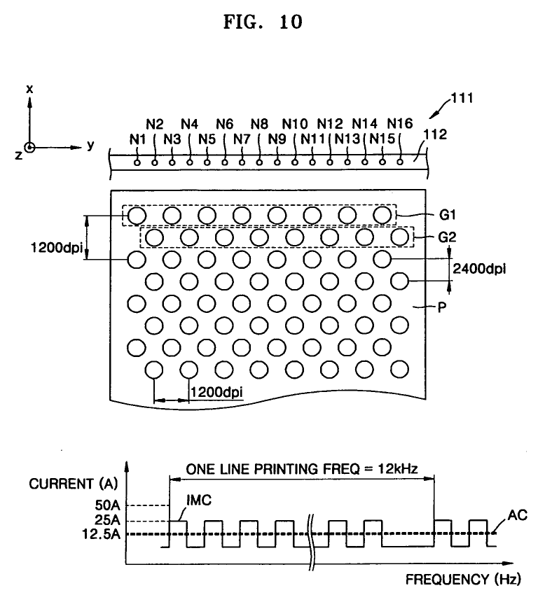

FIG. 9 is a flow chart illustrating a printing method of an image forming apparatus according to an embodiment of the present general inventive concept. The method of FIG. 9 may be usable in the inkjet image forming apparatus 125 of FIGS. 3, 6, and 7 and/or the image forming system of FIG. 6. For example, the method of FIG. 9 may be performed by the control unit 130 of the image forming apparatus 125. Accordingly, the method of FIG. 9 is described below with reference to FIGS. 3-9. FIG. 10 illustrates a printing pattern when image data that corresponds to a single line is divided into two groups for printing.

The inkjet image forming apparatus 125 receives the image data to be printed from the data input unit 135 in operation S10. The user inputs the printing environment through the user interface 240 in operation S20. For example, the user selects a printing mode such as the draft mode, the normal mode, or the resolution enhanced mode. The draft mode or the resolution enhanced mode may be set as a default mode. The printing environment like the printing mode can be varied according to purposes for which the inkjet image forming apparatus 125 is being used. Subsequent image forming processes are changed according to the printing environment input through the user interface 240.

The control unit 130 controls the subsequent image forming processes according to the printing environment input through the user interface 240 in operation S30. If the printing environment input at the operation S20 does not include the resolution enhanced mode, the printing is performed with the printing environment input mode in operation S70. If the printing environment input at the operation S20 includes the resolution enhanced mode, the image data to be printed in a single line is divided into “n” groups (e.g., two groups) in operation S40. The transferring speed of the print medium P is determined according to the number “n” of the divided groups in operation S50. The divided “n” groups are then sequentially printed in “n” lines according to the determined transferring speed of the print medium P in operation S60. Hereinafter, a case in which the image data to be printed in a single line is divided into two groups in the resolution enhanced mode will be described as an example of the printing method of FIG. 9.

Referring to FIG. 10, a horizontal resolution of the image data (i.e., a resolution in the y direction of the printhead 111) is 1200 dots per inch (dpi). Since the printhead 111 is fixed, the horizontal resolution of the image data printed on the print medium P is 1200 dpi. When the print medium P is transferred at a speed of 10 inches per second (ips) and a vertical resolution of the image data, which is the resolution of the image data in the transferring direction of the print medium P, is 1200 dpi, a printing resolution of the inkjet image forming apparatus 125 is 1200 by 1200 dpi. The printhead 111 is driven with a driving frequency of 12 kHz to print the image data that corresponds to the single line.

Referring to FIGS. 6-10, the image data that is input from the data input unit 135 is stored in the memory unit 171. The data dividing unit 172 reads the image data stored in the memory unit 171 and divides the image data to be printed in the single line into two groups G1 and G2. Here, the data dividing unit 172 divides the image data such that ink droplets that correspond to the image data in the same group are ejected from the printhead 111 on each position that corresponds to twice a single nozzle pitch (i.e., every other nozzle). That is, the image data in the group G1 is printed by ejecting ink droplets from odd nozzles N1 through N15, and the image data in the group G2 is printed by ejecting ink droplets from even nozzles N2 through N16. The printhead driving unit 173 separately drives the printhead 111 such that the image data in the each of groups G1 and G2 are respectively printed in corresponding lines. When printing an image by dividing the image data in the above described manner, the image data in one group is printed in parallel, and the image data in the other group is printed by forming a plurality of slanted lines because the print medium P is transferred in the first direction (i.e., the x direction). In addition, the printhead driving unit 173 drives the printhead 111 with the same driving frequency as the driving frequency with which the image data is printed in the single line, and the print speed determining unit 174 sets the transferring speed of the print medium P to ½ of the print medium transferring speed in the normal mode. Accordingly, the vertical resolution becomes 2400 dpi when the image data to be printed in the single line that corresponds to 1200 dpi is divided in half for printing. That is, when the printhead 111 has a printing resolution of 1200 dpi, the printing method according to the present embodiment can realize a vertical resolution of 2400 dpi (or double the printing resolution of the printhead 111), while the conventional printing method has a vertical resolution of 1200 dpi.

As described above, in the printing method according to the present embodiment, the print medium P is transferred at the speed of ½ of the print medium transferring speed in the normal mode and the printhead 111 is driven with the driving frequency of 12 kHz with which the image data is printed in the single line. In addition, the image data of the first group G1 which is divided in half is printed in a first line. The image data of the second group G2, which is not printed with the first line, is printed in a next line (or a second line). A printing pattern printed in this manner is illustrated in FIG. 10.

In the above described embodiments, a size of the data to print in a single line at once decreases by one half, and thus, the instantaneous maximum consumption current (IMC) decreases by one half and the driving frequency of the printhead 111 has a duty of 50%, as illustrated in FIG. 10. Accordingly, the instantaneous maximum consumption current(IMC) is 25 A, and the average consumption current (AC) is 12.5 A(25 A×50%=12.5 A). Thus, the printing method according to the present embodiment can reduce both the instantaneous maximum consumption current and the average consumption current.

The embodiments of the present general inventive concept can be embodied as computer readable codes on a computer readable recording medium. The computer readable recording medium may include any data storage device that can store data which can be thereafter read by a computer system. Examples of the computer readable recording medium include a read-only memory (ROM), a random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. The embodiments of the present general inventive concept may also be embodied in hardware or a combination of hardware and software. For example, the control unit 130 of the inkjet image forming apparatus 125 may be embodied in software, hardware, or a combination thereof.

As described above, in an inkjet image forming apparatus and a printing method according to the various embodiments of the present general inventive concept, image data to be printed in a single line is divided and printed with a predetermined driving frequency. A transferring speed of a print medium is controlled for printing the image data such that an instantaneous maximum consumption current and an average consumption current are reduced, and thus a small capacity power supply can be used to drive the inkjet image forming apparatus. Also, the print medium is slowly transferred and the divided image data is sequentially printed, thereby enhancing printing quality.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet image forming apparatus, comprising:
a print medium transferring unit to transfer a print medium in a first direction;
a printhead which has a nozzle unit with a length that corresponds to at least a width of the print medium and is installed along a second direction;
an ejection driving unit to drive the printhead with a predetermined frequency to print an image on the print medium; and
a control unit which generates control signals to control operations of the print medium transferring unit, the printhead, and the ejection driving unit such that image data printed in a single line is divided into “n” groups and the divided “n” groups are sequentially printed in “n” lines by reducing a transferring speed of the print medium.

2. The apparatus of claim 1, wherein the control unit comprises:
a memory unit to store image data input from a host;
a data dividing unit which reads the image data from the memory unit and divides the image data to be printed in the single line into the divided “n” groups;
a printhead driving unit which separately drives nozzles in the nozzle unit of the printhead such that the image data of each group is printed in a corresponding line; and
a printing speed determining unit which controls the operation of the print medium transferring unit according to a number of the divided “n” groups to reduce the transferring speed of the print medium.

3. The apparatus of claim 2, wherein the data dividing unit divides the image data in each group by alternating “n” times in a total number of nozzles such that ink droplets ejected from the printhead are ejected to each position that corresponds to “n” times a single nozzle pitch to print the image data.

4. The apparatus of claim 2, wherein the printhead driving unit separately drives the printhead such that ink droplets for the divided “n” groups form a plurality of slanted lines on the print medium.

5. The apparatus of claim 4, wherein the printhead driving unit separately drives the printhead such that the plurality of slanted lines have an inclination angle that is the same.

6. The apparatus of claim 2, wherein the printhead driving unit drives the printhead such that the predetermined driving frequency at which the printhead is driven to print the divided “n” groups is equal to a driving frequency when the image data is printed in the single line by operating all corresponding nozzles at the same time.

7. The apparatus of claim 2, wherein the print speed determining unit determines that the print medium is transferred at a speed that is 1/n of a print medium transferring speed in a normal printing mode.

8. The apparatus of claim 2, wherein “n” is equal to 2.

9. An inkjet image forming apparatus, comprising:
a printhead having a plurality of nozzles arranged along a line thereof; and
a control unit to operate the printhead to print a line of image data using the line of nozzles of the printhead simultaneously in a first mode and to print the line of the image data using alternating groups within the line of nozzles sequentially in a second mode.

10. The inkjet image forming apparatus of claim 9, further comprising:
a print medium transferring unit to transfer a print medium to the printhead at a first speed when the control unit operates the printhead in the first mode and a second speed when the control unit operates the printhead in the second mode, and the first speed is greater than the second speed.

11. The inkjet image forming apparatus of claim 9, wherein the printhead is operated at a predetermined frequency in both the first and the second modes.

12. The inkjet image forming apparatus of claim 9, wherein in the first mode, the line of nozzles prints in a single pixel line within a predetermined print area of the print medium, and in the second mode, each of the alternating groups prints to a different pixel line within the predetermined print area of the print medium.

13. The inkjet image forming apparatus of claim 9, wherein the alternating groups comprise a predetermined number of alternating groups, and each nozzle in each alternating group is the predetermined number of nozzles away from an adjacent nozzle in the same alternating group.

14. The inkjet image forming apparatus of claim 9, wherein the alternating groups comprise a predetermined number of alternating groups, and a vertical resolution of an image printed in the second mode is the predetermined number of times greater than a vertical resolution of the image printed in the first mode.

15. The inkjet image forming apparatus of claim 9, wherein the alternating groups comprise a predetermined number of alternating groups, and an instantaneous current provided to drive the printhead to eject ink using the line of nozzles in the first mode is the predetermined number of times greater than an instantaneous current provided to drive the printhead to eject ink using one of the alternating groups.

16. The inkjet image forming apparatus of claim 9, wherein the first mode and the second mode correspond to a normal mode and a high resolution mode, respectively.

17. The inkjet image forming apparatus of claim 9, further comprising:
a user interface to enable a user to select from a plurality of printing environments, and each of the plurality of printing environments corresponds to one of the first and second modes.

18. A printing method of an image forming apparatus having a printhead including a nozzle unit with a length that corresponds to at least a width of a print medium, the method comprising:
dividing image data to be printed in a single line into “n” groups;
determining a transferring speed of the print medium according to a number of the divided “n” groups; and
sequentially printing the divided “n” groups in “n” lines according to the determined transferring speed of the print medium.

19. The method of claim 18, wherein the sequential printing of the divided “n” groups in the “n” lines comprises printing the image data in each group in a corresponding line.

20. The method of claim 19, wherein the image data in each group is divided such that ink droplets ejected from the printhead are ejected to each position that corresponds to “n” times a single nozzle pitch to print the image data.

21. The method of claim 19, wherein the printhead is separately driven such that ink droplets for the divided “n” groups form a plurality of slanted lines on the print medium.

22. The method of claim 21, wherein the printhead is separately driven such that the plurality of slanted lines have an inclination angle that is the same.

23. The method of claim 19, wherein the printhead is driven such that a driving frequency at which the printhead is driven in the divided “n” groups is equal to a driving frequency when the image data is printed in the single line.

24. The method of claim 18, wherein the print medium is transferred at a speed that is 1/n of a print medium transferring speed in a normal printing mode.

25. The method of claim 18, wherein “n” is equal to 2.

26. A control method of an inkjet image forming apparatus including a printhead having a plurality of nozzles arranged along a line thereof, the method comprising:
controlling the printhead between a first mode in which the printhead prints a line of image data using the line of nozzles of the printhead simultaneously and a second mode in which the printhead prints the line of the image data using alternating groups within the line of nozzles sequentially in a second mode.

27. The method of claim 26, further comprising:
transferring a print medium to the printhead at a first speed when the printhead operates in the first mode and a second speed when the printhead operates in the second mode, and the first speed is greater than the second speed.

28. The method of claim 26, wherein in the first mode, the line of nozzles prints in a single pixel line within a predetermined print area of the print medium, and in the second mode, each of the alternating groups prints to a different pixel line within the predetermined print area of the print medium.

29. The method of claim 26, wherein the alternating groups comprise a predetermined number of alternating groups, and each nozzle in each alternating group is the predetermined number of nozzles away from an adjacent nozzle in the same alternating group.

30. The method of claim 26, wherein the alternating groups comprise a predetermined number of alternating groups, and a vertical resolution of an image printed in the second mode is the predetermined number of times greater than a vertical resolution of the image printed in the first mode.

31. The method of claim 26, wherein the alternating groups comprise a predetermined number of alternating groups, and an instantaneous current provided to drive the printhead to eject ink using the line of nozzles in the first mode is the predetermined number of times greater than an instantaneous current provided to drive the printhead to eject ink using one of the alternating groups.

32. The method of claim 26, wherein the first mode and the second mode correspond to a normal mode and a high resolution mode, respectively.

33. The method of claim 26, further comprising:
enabling a user to select from a plurality of printing environments, and each of the plurality of printing environments corresponds to one of the first and second modes.
